(19) United States
(12) Patent Application Publication
(10) Pub. No.: US 2026/0063975 A1
(43) Pub. Date: Mar. 5, 2026

(54) MOVING BODY MOUNTED DEVICE

(71) Applicant: JVCKENWOOD Corporation, Yokohama-shi (JP)

(72) Inventor: Kiriko YAMADA, Yokohama-shi (JP)

(21) Appl. No.: 19/382,642

(22) Filed: Nov. 7, 2025

Related U.S. Application Data
(63) Continuation of application No. PCT/JP2024/015978, filed on Apr. 24, 2024.

(30) Foreign Application Priority Data
May 8, 2023 (JP) 2023-076785

(51) Int. Cl. G03B 17/56; B60R 11/00; B60R 11/04

(52) U.S. Cl. CPC G03B 17/561; B60R 11/04; B60R 2011/0003; B60R 2011/0085

(57) ABSTRACT

A moving body mounted device includes: a body; a first attachment portion arranged on a first side in a first direction relative to the body, and attachable to a first attachment target member of a moving body; a second attachment portion arranged on a second side opposite to the first side in the first direction relative to the body, and attachable to a second attachment target member of the moving body; and a fixture for fixing the first attachment portion, the body, and the second attachment portion to each other. The first attachment portion and the second attachment portion are independently rotatable about an axis extending in the first direction relative to the body. The fixture enables each of the first attachment portion and the second attachment portion to be fixed in a desired rotational position relative to the body.

### CROSS-REFERENCE TO RELATED APPLICATIONS

The present application is a continuation of International Application No. PCT/JP2024/015978, filed on Apr. 24, 2024, and based upon and claims the benefit of priority from Japanese Patent Applications No. 2023-076785, filed on May 8, 2023, the entire contents of which are incorporated herein by reference.

### TECHNICAL FIELD

The present disclosure relates to a moving body mounted device.

### BACKGROUND

JP 2020-199800 A describes a driving recorder that includes a body including a camera, a support that protrudes upward from the body, and a base that has a plate shape and is formed at an upper distal end of the support. This driving recorder is attached to a windshield of a vehicle, which is a type of a moving body, by sticking the base to an inner surface of the windshield by using a double-sided tape.

In the support of the driving recorder described in JP 2020-199800 A, an arm and a column that are obtained by dividing the support into a portion closer to the body and a portion closer to the base axially engage with each other to be rotatable upward/downward about a horizontal axis, and the arm and the column can be fastened and fixed in an arbitrary rotational position by a nut. This enables a user to rotatably adjust, upward and downward, an optical axis direction of the camera relative to the windshield.

### SUMMARY

A driving recorder is generally mounted on an automobile. Here, assuming that the moving body includes an automobile, a railway vehicle, an aircraft, a ship, an airship, a drone, and the like, the driving recorder can be classified as a moving body mounted device. In a case where the moving body mounted device is a camera device such as a driving recorder, it is requested that the moving body mounted device can be attached to different surfaces of the moving body in such a way that an orientation of a body of the moving body mounted device, that is, a direction of an optical axis, is changeable, and the moving body mounted device have satisfactory usability. However, in order to respond to this request by using a conventional technique as described in JP 2020-199800 A, the base needs to be rotatable in a wide range in a forward/backward direction relative to the body, and the entirety of the camera device increases in size.

A problem to be solved by the present disclosure is to provide a moving body mounted device that is small in size but can be attached to different portions of a moving body in such a way that an orientation of a body of the moving body mounted device is changeable, and has satisfactory usability.

In order to solve the problem described above, a moving body mounted device according to an embodiment includes a body, a first attachment portion, a second attachment portion, and a fixture. The first attachment portion is arranged on a first side in a first direction relative to the body, and is attachable to a first attachment target member of a moving body. The second attachment portion is arranged on a second side opposite to the first side in the first direction relative to the body, and is attachable to a second attachment target member of the moving body. The fixture fixes the body, the first attachment portion, and the second attachment portion to each other. The first attachment portion and the second attachment portion are independently rotatable about an axis extending in the first direction relative to the body. The fixture enables each of the first attachment portion and the second attachment portion to be fixed in a desired rotational position relative to the body.

The moving body mounted device according to the embodiment can exhibit an effect that the moving body mounted device is small in size but can be attached to different portions of a moving body in such a way that an orientation of a body of the moving body mounted device is changeable, and has satisfactory usability.

### BRIEF DESCRIPTION OF THE DRAWINGS

FIG. 1 is a front view illustrating a moving body mounted device according to an embodiment.

FIG. 2A is a left-hand side view illustrating the moving body mounted device according to the embodiment.

FIG. 2B is a right-hand side view illustrating the moving body mounted device according to the embodiment.

FIG. 3A is a cross-sectional view taken in position S3A-S3A in FIG. 2A.

FIG. 3B is a cross-sectional view taken in position S3B-S3B in FIG. 2A.

FIG. 4 is a perspective view illustrating the moving body mounted device according to the embodiment when viewed from an obliquely upper left front side.

FIG. 5 is an assembly diagram illustrating the moving body mounted device according to the embodiment.

FIG. 6A is a diagram illustrating a first attachment mode of the moving body mounted device according to the embodiment.

FIG. 6B is a diagram illustrating a second attachment mode of the moving body mounted device according to the embodiment.

FIG. 6C is a diagram illustrating a third attachment mode of the moving body mounted device according to the embodiment.

FIG. 7A is a front view illustrating a moving body mounted device according to a first variation of the embodiment.

FIG. 7B is a cross-sectional view taken in position Sb-Sb in FIG. 7A.

FIG. 8 is a front view of a partial cross section illustrating a moving body mounted device according to a second variation of the embodiment.

### DETAILED DESCRIPTION

Hereinafter, a moving body mounted device 91 according to an embodiment will be described in detail with reference to the drawings.

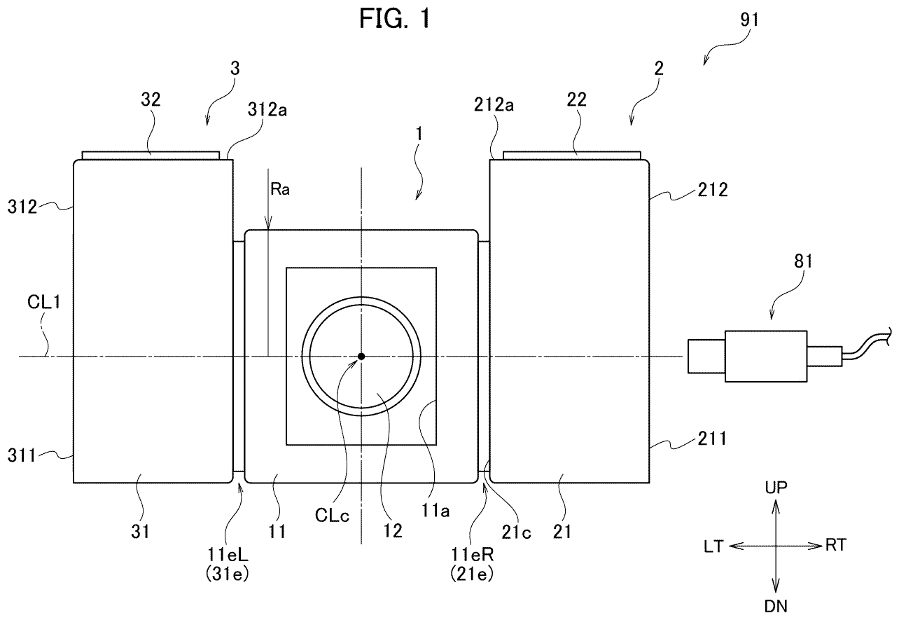

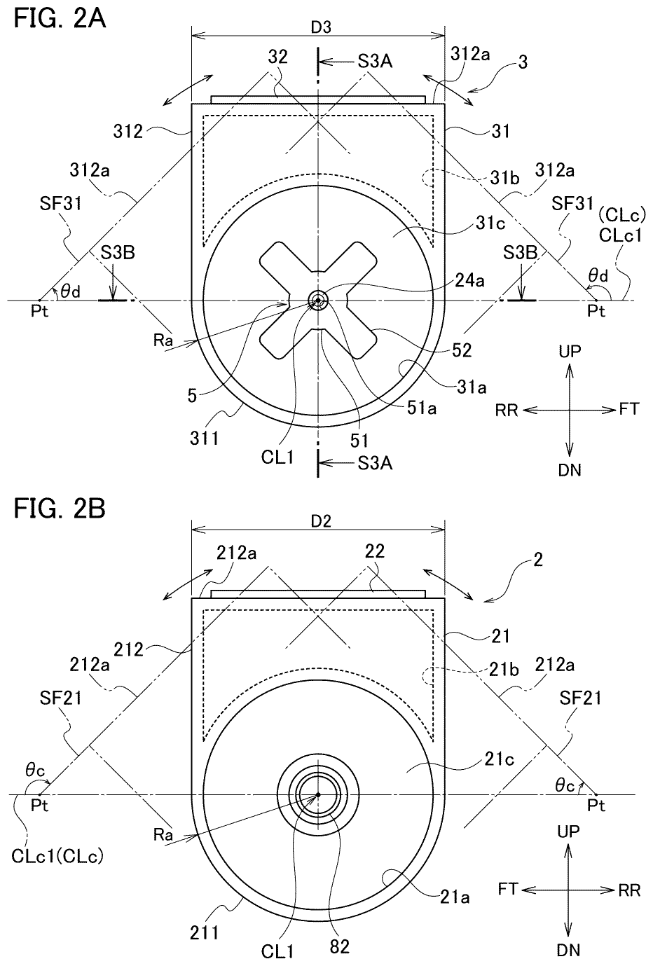

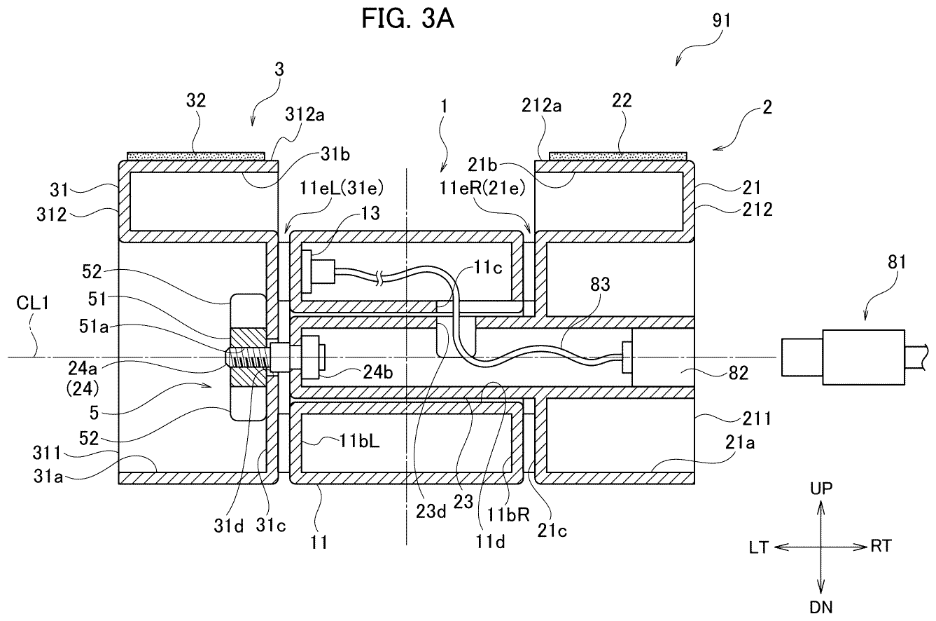

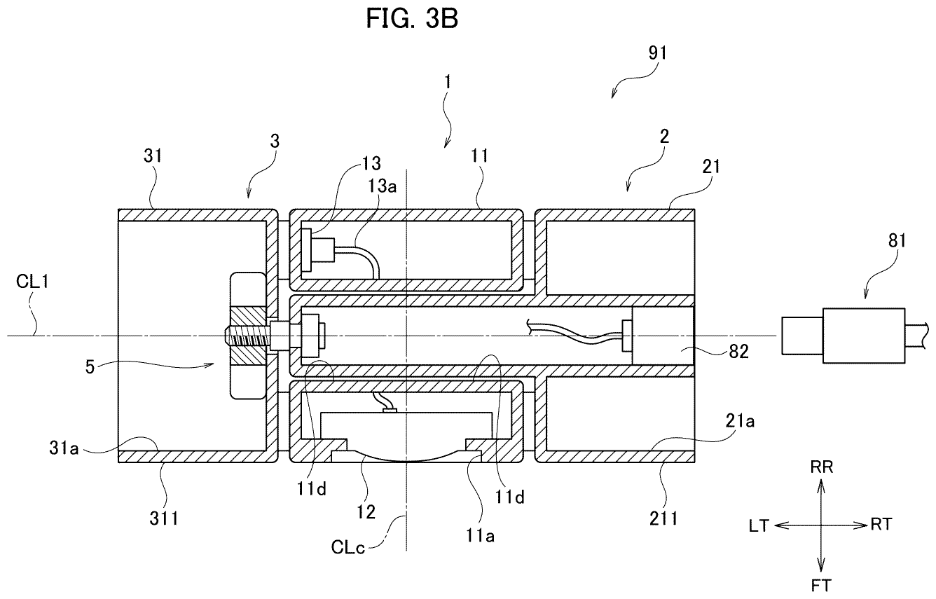

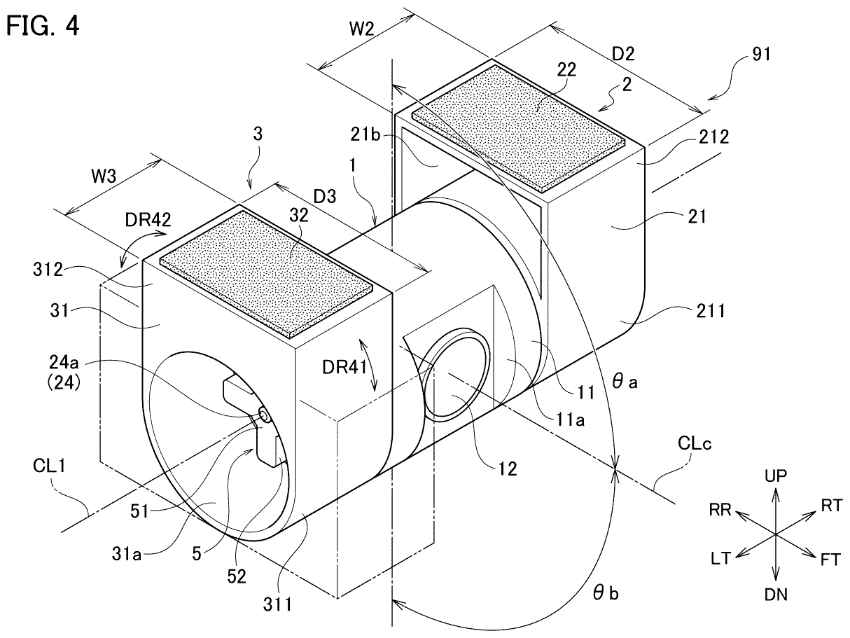

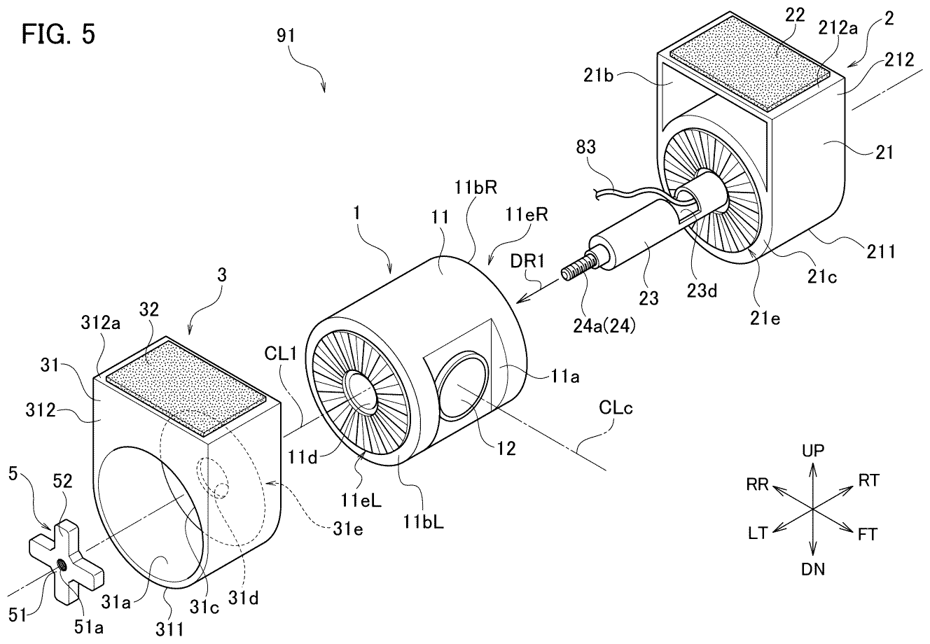

The moving body mounted device 91 is a camera device (an in-vehicle camera) that is mounted on an automobile, which is a type of a moving body. A configuration of the moving body mounted device 91 will be described with reference to FIGS. 1 to 5. FIG. 1 is a front view illustrating the moving body mounted device 91 according to the embodiment. FIG. 2A is a left-hand side view illustrating the moving body mounted device 91, and FIG. 2B is a right-hand side view illustrating the moving body mounted device 91. FIG. 3A is a cross-sectional view taken in position S3A-S3A in FIG. 2A, and FIG. 3B is a cross-sectional view taken in position S3B-S3B in FIG. 2A. FIG. 4 is a perspective view illustrating the moving body mounted device 91 when viewed from an obliquely upper left front side. FIG. 5 is an assembly diagram illustrating the moving body mounted device 91. For convenience of description, each of upward (UP), downward (DN), leftward (LT), rightward (RT), forward (FT), and backward (RR) directions is defined as a direction illustrated with an arrow in FIG. 4, and is illustrated with the arrow in each of the drawings.

As illustrated in FIG. 5, the moving body mounted device 91 serving as an in-vehicle camera includes a body 1, a first attachment portion 2, a second attachment portion 3, and a fixture 5 serving as a nut member. As illustrated in FIGS. 1 and 4, the body 1 includes a housing 11 that has a cylindrical shape and has an outer peripheral surface having a radius Ra with an axis CL1 extending in a crosswise direction (a first direction) as a center. The housing 11 is formed of, for example, resin.

The housing 11 includes, in a front portion, a recess 11a that has been hollowed out to form a plane extending in crosswise and forward/backward directions with a predetermined width in the crosswise direction. As also illustrated in FIG. 3B, a camera unit 12 is housed in the housing 11. A lens of the camera unit 12 is exposed to a central portion of a bottom surface of the recess 11a. An optical axis CLc of the camera unit 12 intersects with the axis CL1 and extends in the forward/backward direction in the posture illustrated in FIGS. 1 and 4 of the body 1. The optical axis CLc indicates a direction of a center position of an image captured by the camera unit 12, that is, an imaging direction.

As illustrated in FIGS. 3A and 3B, the housing 11 includes a through-hole 11d that penetrates crosswise with the axis CL1 as a center. As illustrated in FIG. 3A, a slit 11c that is open in an elongated shape up to a right-hand end in parallel with the axis CL1 is formed in a portion closer to a right-hand end of an inner wall of the through-hole 11d. In an internal space of the housing 11, a substrate 13 having an arc shape in a side view is housed. The substrate 13 is attached to an inner surface of a left-hand wall 11bL (see FIGS. 3A and 5). The substrate 13 and the camera unit 12 are electrically connected by a cable 13a.

As illustrated in FIG. 5, the left-hand wall 11bL of the housing 11 includes an engagement portion 11eL that slightly protrudes leftward on a left outer surface and includes recesses and protrusions alternately in a circumferential direction. The recesses and protrusions radially extend with the axis CL1 as a center. Similarly, a right-hand wall 11bR of the housing 11 includes an engagement portion 11eR that slightly protrudes rightward on a right outer surface and includes recesses and protrusions alternately in the circumferential direction. The recesses and protrusions radially extend with the axis CL1 as a center.

The first attachment portion 2 is arranged on a right-hand side (a first side) of the body 1. The second attachment portion 3 is arranged on a left-hand side (a second side) of the body 1 that is an opposite side of the first attachment portion 2.

The first attachment portion 2 includes a housing 21. In the housing 21, as illustrated in FIGS. 2B and 5, a lower portion is a semicylinder 211 that has a semicylindrical shape and has an outer peripheral surface having the radius Ra that is the same as that of the body 1 with the axis CL1 as a center, and an upper portion is a prism 212 that has a prismatic shape and is connected to an upper portion of the semicylinder 211 without a step. Accordingly, a depth D2 (see FIGS. 2B and 4) in the forward/backward direction of the prism 212 is twice the radius Ra.

On an upper surface 212a of the prism 212, an adhesive member 22 that is used to attach the first attachment portion 2 to an attachment target member of the moving body is stuck. The adhesive member 22 is, for example, a thick double-sided tape.

As illustrated in FIGS. 2B and 3A, the first attachment portion 2 includes a recess 21a that is open at a right-hand end and has been hollowed leftward in a circular shape with the axis CL1 as a center. In addition, the prism 212 includes a lightening portion 21b that is open at a left-hand end and has been hollowed rightward. The first attachment portion 2 includes a shaft column 23 that is formed to extend rightward into the recess 21a and protrude leftward from a left-hand wall 21c (see FIG. 3A) with the axis CL1 as a center. The shaft column 23 can be inserted into the through-hole 11d of the housing 11 with less play.

The shaft column 23 includes an outer frame, and includes a space inside. A receptacle 82 is attached to a right-hand end of the space inside the shaft column 23. As illustrated in FIG. 3A, a connection plug 81 is detachably attached to the receptacle 82 from the outside. The shaft column 23 also includes a cord hole 23d that is an opening extending in the circumferential direction. The receptacle 82 and the substrate 13 are electrically connected by a cable 83. A processing unit that converts an image captured by the camera unit 12 into an electric signal is mounted on the substrate 13. The image captured by the camera unit 12 is output as an image signal to the receptacle 82 via the cable 13a, the processing unit of the substrate 13, and the cable 83, and the image signal is output to an external device via a connection plug connected to the receptacle 82.

A stud 24 is fixed to a left-hand end of the shaft column 23 by a nut 24b to protrude leftward with the axis CL1 as an axis. A distal end of the stud 24 is a male screw column 24a including a male screw.

As illustrated in FIG. 5, the first attachment portion 2 includes, on a left outer surface of the left-hand wall 21c, an engagement portion 21e that slightly protrudes leftward and includes recesses and protrusions alternately in the circumferential direction. The recesses and protrusions radially extend with the axis CL1 as a center. The engagement portion 21e can engage with the engagement portion 11eR of the body 1 in a recess-protrusion relationship.

The second attachment portion 3 includes a housing 31. In the housing 31, as illustrated in FIGS. 2A and 5, similarly to the first attachment portion 2, a lower portion is a semicylinder 311 that has a semicylindrical shape and has an outer peripheral surface having the radius Ra that is the same as that of the body 1 with the axis CL1 as a center, and an upper portion is a prism 312 that has a prismatic shape and is connected to an upper portion of the semicylinder 311 without a step. Accordingly, a depth D3 (see FIGS. 2A and 4) in the forward/backward direction of the prism 312 is twice the radius Ra.

On an upper surface 312a of the prism 312, an adhesive member 32 that is used to attach the second attachment portion 3 to an attachment target member of the moving body is stuck. The adhesive member 32 is, for example, a thick double-sided tape.

As illustrated in FIGS. 2A and 3A, the second attachment portion 3 includes a recess 31a that is open at a left-hand end and has been hollowed rightward in a circular shape with the axis CL1 as a center. In addition, the prism 312 includes a lightening portion 31b that is open at a right-hand end and has been hollowed leftward. The second attachment portion 3 includes a through-hole 31d with the axis CL1 as a center in a right-hand wall 31c serving as a bottom of the recess 31a. An inner diameter of the through-hole 31d is larger than an outer diameter of a portion that protrudes from the shaft column 23 in the stud 24.

The second attachment portion 3 includes, on a right outer surface of the right-hand wall 31c, an engagement portion 31e that slightly protrudes rightward and includes recesses and protrusions alternately in the circumferential direction. The recesses and protrusions radially extend with the axis CL1 as a center (see FIG. 5). The engagement portion 31e can engage with the engagement portion 11eL of the body 1 in a recess-protrusion relationship.

As illustrated in FIGS. 3A and 5, the fixture 5 includes a base 51 including a female screw 51a, and a plurality of arms 52 that radially extends outward in a radial direction from the base 51. In this example, the fixture 5 includes four arms 52 at equiangular intervals. The female screw 51a is screwed onto the male screw column 24a of the stud 24 of the first attachment portion 2. The arms 52 serve as finger hooks when the fixture 5 is rotated to screw the female screw 51a onto and out of the male screw column 24a.

The members described above are assembled into the moving body mounted device 91. An assembling procedure will be described with reference to FIG. 5 and the like.

As illustrated in FIG. 3A, the cable 83 drawn out from substrate 13 has been connected in advance to the receptacle 82 through the slit 11c and the cord hole 23d. In this state, as illustrated in FIG. 5, the shaft column 23 to which the stud 24 is fixed to protrude at the distal end in the first attachment portion 2 is inserted into the through-hole 11d of the housing 11 of the body 1 from a right-hand side (see arrow DR1). Then, the engagement portion 11eR of the right-hand wall 11bR of the body 1 and the engagement portion 21e of the first attachment portion 2 are engaged with each other in a desired rotational position around the axis CL1. In this state, as illustrated in FIG. 3A, the male screw column 24a of the stud 24 protrudes leftward from the left-hand wall 11bL of the body 1.

In FIG. 5, the body 1 and the first attachment portion 2 around the axis CL1 are illustrated in a posture in which the optical axis CLc of the body 1 faces forward and the upper surface 212a of the first attachment portion 2 serves as a plane that extends forward/backward and crosswise.

Next, the second attachment portion 3 is brought close to the body 1 in such a way that the male screw column 24a of the stud 24 is inserted into the through-hole 31d of the second attachment portion 3. Next, the female screw 51a of the fixture 5 is screwed onto the male screw of the male screw column 24a. Then, the engagement portion 11eL of the left-hand wall 11bL of the body 1 and the engagement portion 31e of the second attachment portion 3 are engaged with each other to be located in a desired rotational position around the axis CL1, and in this state, the fixture 5 is rotated with fingers or the like to be fastened. In the example illustrated in FIG. 5, fastening and fixing are performed by using the fixture 5 in such a way that an upper surface 312a of the second attachment portion 3 and the upper surface 212a of the first attachment portion 2 are parallel to each other. Thus, the moving body mounted device 91 is assembled.

As is apparent from this configuration, the moving body mounted device 91 can independently adjust a rotational position of the body 1 relative to each of the first attachment portion 2 and the second attachment portion 3. Here, it is assumed that angles of the body 1 relative to the first attachment portion 2 and the second attachment portion 3 are angles θc and θd, respectively. The angles θc and θd are defined as follows, in a posture in which the body 1 has the optical axis CLc extending forward and backward and an imaging direction is a forward direction.

For the second attachment portion 3, it is assumed that, in FIG. 2A of the left-hand side view, the angle θd is an angle formed by an extending plane SF31 of the upper surface 312a of the second attachment portion 3 and the optical axis CLc, and is a counterclockwise angle by using, as a reference, the optical axis CLc1 in the imaging direction (on a front side) with respect to an intersection Pt of the extending plane SF31 and the optical axis CLc. In this case, the angle θd is an obtuse angle in a posture in which the second attachment portion 3 falls forward from among postures of virtual lines illustrated with a dash-double-dotted line. In addition, the angle θd is an acute angle in a posture in which the second attachment portion 3 falls backward from among the postures of the virtual lines illustrated with a dash-double-dotted line. Furthermore, in a posture illustrated with a solid line, the angle θd is zero degree.

For the first attachment portion 2, it is assumed that, in FIG. 2B of the right-hand side view, the angle θc is an angle formed by an extending plane SF21 of the upper surface 212a of the first attachment portion 2 and the optical axis CLc, and is a clockwise angle by using, as a reference, the optical axis CLc1 in the imaging direction (on the front side) with respect to an intersection Pt of the extending plane SF21 and the optical axis CLc. In this case, the angle θc is an obtuse angle in a posture in which the first attachment portion 2 falls forward from among postures of virtual lines illustrated with a dash-double-dotted line. In addition, the angle θc is an acute angle in a posture in which the first attachment portion 2 falls backward from among the postures of the virtual lines illustrated with a dash-double-dotted line. Furthermore, in a posture illustrated with a solid line, the angle θc is zero degree. Rotatable ranges of the first attachment portion 2 and the second attachment portion 3, that is, possible ranges of the angles θc and θd, are each set in an arbitrary range between zero degree and 180 degrees.

The first attachment portion 2 and the second attachment portion 3 are rotatable about the axis CL1 relative to the body 1 in such a way that the angle θc and the angle θd independently have different values. In a case where the first attachment portion 2 and the second attachment portion 3 are attached to an attachment target member on an identical plane, the angle θc and the angle θd are equal. In addition, in a case where the first attachment portion 2 and the second attachment portion 3 are respectively attached to two attachment target members on planes having different angles, the angle θc and the angle θd have different values.

As illustrated in FIG. 4, when the first attachment portion 2 and the second attachment portion 3 have a posture in which the upper surface 212a and the upper surface 312a of the respective attachment portions are horizontal planes, it is assumed that in a relative rotation angle of the body 1, an upper portion and a lower portion from a reference position where the optical axis CLc is horizontally directed forward are an angle θa and an angle θb, respectively. In this case, respective maximum values of the angles θa and θb are 90 degrees, for example. The maximum values of the angles θa and θb can be arbitrarily set. The angle θa and the angle θb are not necessarily equal. In addition, the first attachment portion 2 and the second attachment portion 3 are independently rotatable about the axis CL1 relative to the body 1. In FIG. 4, as illustrated with a dash-double-dotted line, the second attachment portion 3 is rotatable clockwise about the axis CL1 by, for example, 90 degrees relative to the body (see arrow DR41), and is rotatable counterclockwise by, for example, 90 degrees (see arrow DR 42). The same is applied to the first attachment portion 2.

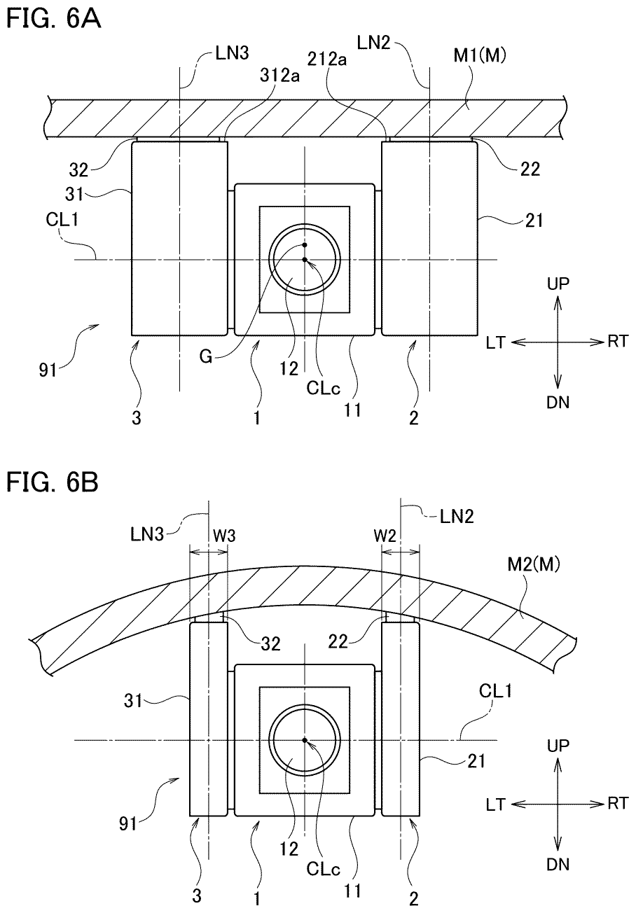

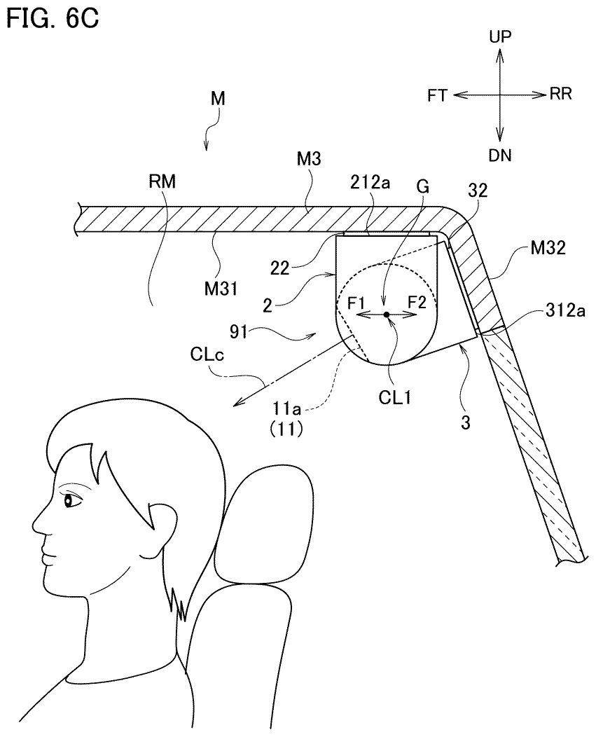

By employing the configuration described above, the moving body mounted device 91 can be attached to an attachment target member in various attachment modes. As specific examples, the following first to third attachment modes will be described with reference to FIGS. 6A to 6C, respectively.

### (First Attachment Mode)

FIG. 6A is a front view illustrating a first attachment mode in which the moving body mounted device 91 has been attached to an attachment target member M1 of a moving body M. The attachment target member M1 in this case is a flat plate. In the first attachment mode, the first attachment portion 2 and the second attachment portion 3 are fixed in the same angular position around the axis CL1 relative to the body 1 in such a way that the upper surface 212a and the upper surface 312a of the respective attachment portions are parallel to each other.

As illustrated in FIG. 6A, in the moving body mounted device 91, the center of gravity G of the body 1 is preferably at the center of the width of the body 1 (in a position where the width is divided into two pieces) in the crosswise direction in a front view. As a result, the body 1 is arranged between an attachment axis LN2 and an attachment axis LN3 that indicate respective attachment center positions in the crosswise direction of the first attachment portion 2 and the second attachment portion 3. Then, the center of gravity G of the body 1 is located in a position where a distance between the attachment axis LN2 and the attachment axis LN3 is divided into two pieces. As a result, in a state where the moving body mounted device 91 has been attached to the attachment target member M1, a moment is balanced in contrast to what is called cantilever support. Therefore, the first attachment portion 2 and the second attachment portion 3 have improved strength of attachment, and the first attachment portion 2 and the second attachment portion 3 are hardly detached even if a strong external force is applied, and high attachment reliability can be obtained.

A position in the crosswise direction of the center of gravity G of the body 1 is not necessarily strictly at the center of the width of the body 1. If the position is roughly at the center or near the center, a slight moment is generated, and an influence on the strength of attachment can be substantially ignored.

### (Second Attachment Mode)

FIG. 6B is a front view illustrating a second attachment mode in which the moving body mounted device 91 has been attached to an attachment target member M2 of the moving body M. The attachment target member M2 in this case is a member that is curved to protrude upward. In the second attachment mode, similarly, the first attachment portion 2 and the second attachment portion 3 are fixed in the same angular position relative to the body 1 in such a way that the upper surface 212a and the upper surface 312a of the respective attachment portions are parallel to each other. In addition, if a width W2 and a width W3 in the crosswise direction of the first attachment portion 2 and the second attachment portion 3 are set to be smaller, the followability of adhesive members 22 and 32 to a curved surface of the attachment target member M2 is further improved, and this is preferable. Specifically, it is preferable that the width W2 be smaller than a depth D2 in the first attachment portion 2, and the width W3 be smaller than a depth D3 in the second attachment portion 3. Moreover, it is more preferable that the widths W2 and W3 be set to half or less of the depths D2 and D3, respectively. As is apparent from FIG. 6B, the attachment target member M2 may have a curved surface that protrudes downward as long as the attachment target member M2 does not interfere with the body 1.

In the second attachment mode, similarly to the first attachment mode, the moving body mounted device 91 is attached to the attachment target member M2 in two places that are separated from each other in the crosswise direction, the first attachment portion 2 and the second attachment portion 3, and the body 1 is supported between the first attachment portion 2 and the second attachment portion 3. Stated another way, a state in which the moment is substantially balanced or a state close to the state is obtained in contrast to what is called cantilever support. Therefore, although the attachment target member M2 has a curved surface, the first attachment portion 2 and the second attachment portion 3 have improved strength of attachment, and the first attachment portion 2 and the second attachment portion 3 are hardly detached even if a strong external force is applied, and high attachment reliability can be obtained.

### (Third Attachment Mode)

FIG. 6C is a side view of a partial cross section illustrating a third attachment mode in which the moving body mounted device 91 has been attached to an attachment target member M3 of the moving body M. The attachment target member M3 in this case is a plate-shaped member that defines a room RM of the moving body M, and includes a first wall M31 serving as a ceiling and a second wall M32 serving as a back wall that is bent obliquely downward from a rear edge of the first wall M31 (for example, downward by about 70 degrees from an extending plane of the first wall M31).

The moving body mounted device 91 has been attached to the attachment target member M3 in such a way that the upper surface 212a of the first attachment portion 2 and the upper surface 312a of the second attachment portion 3 are not parallel to each other. Specifically, the first attachment portion 2 and the second attachment portion 3 have been attached to the first wall M31 and the second wall M32, respectively, in such a way that the first attachment portion 2 has a rotation posture in which the upper surface 212a is parallel to a surface of the first wall M31, and the second attachment portion 3 has a rotation posture in which the upper surface 312a is parallel to the second wall M32. As a result, in the moving body mounted device 91, the first attachment portion 2 and the second attachment portion 3 can be attached to two attachment target members that extend in different directions, respectively.

Assuming that a position of the center of gravity G of the moving body mounted device 91 is on the axis CL1, as illustrated in FIG. 6C, it can be considered that a forward inertial force F1 is applied to the center of gravity G when sudden braking is applied while the moving body M moves forward, and a backward inertial force F2 is applied to the center of gravity G when the moving body M suddenly starts. In a conventional device including only one attachment portion, for example, the body is only attached to the first wall M31 serving as a ceiling. In this case, a peeling force due to moments caused by the inertial forces F1 and F2 is applied to the attachment portion, and therefore there is a concern about a decrease in adhesive strength. In contrast, the moving body mounted device 91 includes two attachment portions, the first attachment portion 2 and the second attachment portion 3, and respective rotation postures of the first attachment portion 2 and the second attachment portion 3 can be independently set. Therefore, the moving body mounted device 91 can be attached to both the first wall M31 and the second wall M32.

In this case, a moment that is applied to an attachment portion between the second attachment portion 3 and the second wall M32 due to the inertial force F1 and the inertial force F2 is relatively small. Therefore, the moving body mounted device 91 has the maintained strength of attachment to the attachment target member M3, and high strength of attachment is obtained. In addition, the body 1 can be freely set in a desired rotational position around the axis CL1 regardless of the rotational positions of the first attachment portion 2 and the second attachment portion 3, and therefore the optical axis CLc can be set to be directed in a desired direction regardless of an extending direction of the attachment target member M3. In the example illustrated in FIG. 6C, in order to image the inside of the room RM, the optical axis CLc has been set to be directed obliquely forward and downward.

The moving body mounted device 91 has the configuration described above, and therefore the moving body mounted device 91 is not limited to the purpose of imaging the inside of the room RM, as in the third attachment mode, and the moving body mounted device 91 can be attached to an outer surface of the moving body M to image a situation around the moving body M.

As described above in detail, in the moving body mounted device 91, the body 1 is rotatable about the axis CL1 without protruding outward from the outer shapes of the first attachment portion 2 and the second attachment portion 3 in a side view. Therefore, the moving body mounted device 91 can be configured to be small in size. In addition, the moving body mounted device 91 enables the first attachment portion 2 and the second attachment portion 3 to be fixed in different rotational positions around the axis CL1. Therefore, the moving body mounted device 91 is small in size but can be attached to different portions of the moving body M, and an orientation of the body 1 can also be changed. As described above, the moving body mounted device 91 has satisfactory usability.

Stated another way, in the moving body mounted device 91, the first attachment portion 2 and the second attachment portion 3 are independently rotatable relative to the body 1 about the axis CL1 that extends in the first direction (the crosswise direction) in a state where the fixture 5 has been screwed out and pressing has been released. Then, pressing according to the screwing of the fixture 5 causes the first attachment portion 2 and the second attachment portion 3 to be fixed in such a way that rotational positions around the axis CL1 are desired positions.

The embodiment described above in detail is not limited to the configuration described above, and may cover variations made without departing from the gist of the present invention.

The engagement portion 11eL and the engagement portion 31e that engages with the engagement portion 11eL may be omitted. In addition, the engagement portion 11eR and the engagement portion 21e that engages with the engagement portion 11eR may be omitted. In a case where the engagement portion 31e and the like are omitted, the fixture 5 is fastened to bring the body 1 into direct surface contact with the first attachment portion 2 and the second attachment portion 3, and the frictional force between both surfaces restricts rotation. In addition, a rotation angle of fixing is not limited to every pitch of unevenness, and the first attachment portion 2 and the second attachment portion 3 can be fixed while being finely adjusted at arbitrary rotation angles.

The shaft column 23 may be provided in the second attachment portion 3, and in this case, the receptacle 82 is arranged in the second attachment portion 3. In addition, a pair of shaft columns that extend leftward and rightward along the axis CL1 may be formed in the body 1, and the first attachment portion 2 and the second attachment portion 3 may be fastened by using respective nut members different from each other. In this case, as the fixture 5, two fixtures, a first fixture that presses and fixes the first attachment portion 2 against the body 1 and a second fixture that presses and fixes the second attachment portion 3 against the body 1, are included.

The shapes of the first attachment portion 2 and the second attachment portion 3 in a side view are not limited to the shapes illustrated in FIGS. 2A and 2B, and are freely set. In addition, the body 1 does not necessarily have a cylindrical shape with the axis CL1 as an axis, and may have a rectangular tubular shape, an elliptical cylindrical shape, a triangular tubular shape, or the like.

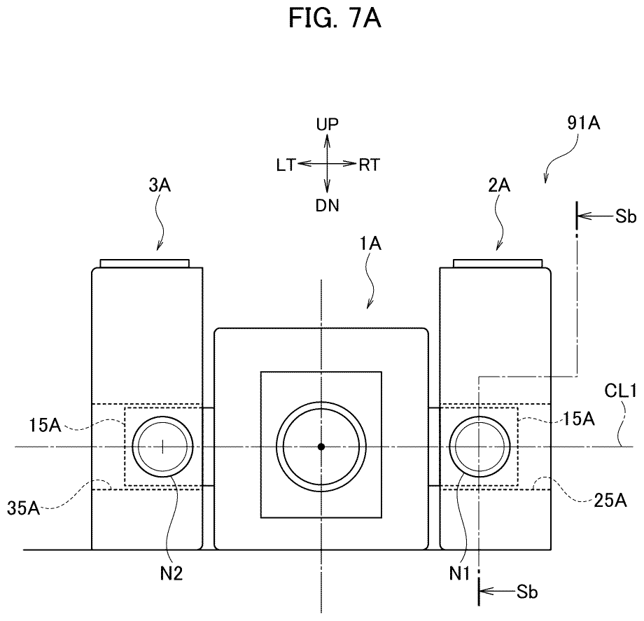

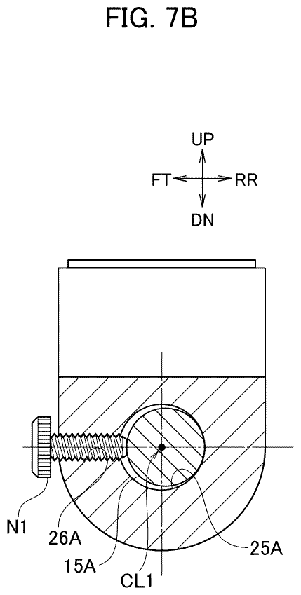

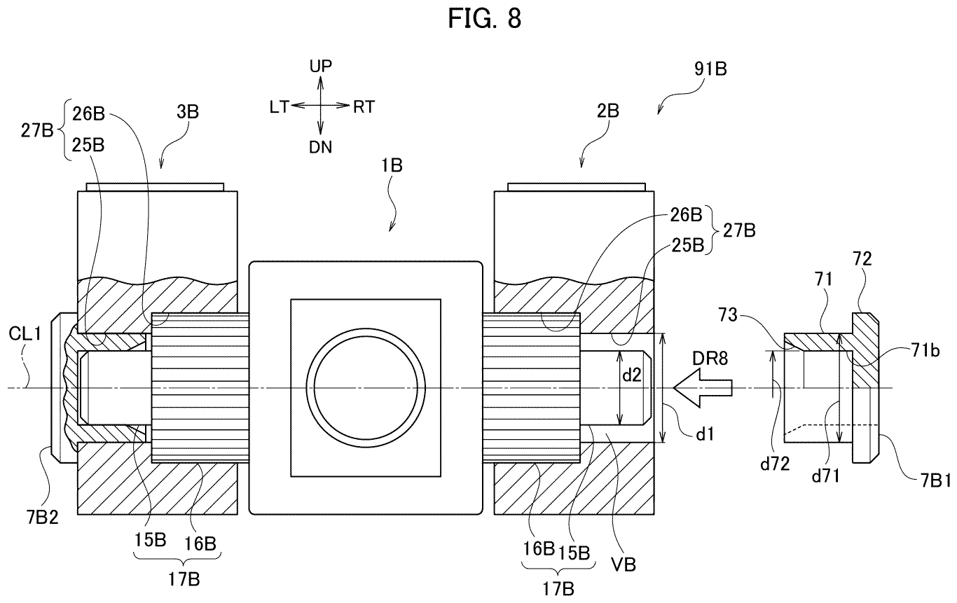

A structure of fixing the body 1, the first attachment portion 2, and the second attachment portion 3 is not limited to a structure of fastening in an axial direction by using the fixture 5. For example, a structure according to any one of a first variation and a second variation described below can be employed, and the first variation and the second variation will be described with reference to FIGS. 7A and 7B and FIG. 8, respectively. FIG. 7A is a front view illustrating a moving body mounted device 91A according to the first variation of the embodiment. FIG. 7B is a cross-sectional view taken in position Sb-Sb in FIG. 7A. FIG. 8 is a front view of a partial cross section illustrating a moving body mounted device 91B according to the second variation of the embodiment.

### (First Variation)

As illustrated in FIGS. 7A and 7B, the moving body mounted device 91A according to the first variation of the embodiment includes a body 1A, a first attachment portion 2A, and a second attachment portion 3A. The body 1A includes a pair of protruding shafts 15A that have a cylindrical shape and extend leftward and rightward from both left-hand and right-hand surfaces with the axis CL1 as a central axis. The first attachment portion 2A and the second attachment portion 3A respectively include a through-hole 25A and a through-hole 35A into which the protruding shafts 15A can be inserted with a slight backlash. Thus, by respectively inserting the pair of protruding shafts 15A into the through-hole 25A and the through-hole 35A, relative rotational positions between the body 1A and the first attachment portion 2A and between the body 1A and the second attachment portion 3A can be freely set.

On the other hand, as illustrated in FIG. 7B, the first attachment portion 2A includes a hole 26A that includes a female screw in the radial direction of the through-hole 25A, and a set screw N1 with a knob serving as a first fixture is screwed into the hole 26A. This can restrict a rotation and an axial movement of the protruding shaft 15A that has been inserted into the through-hole 25A according to the screwing of the set screw N1 by using fingers or the like, and the first attachment portion 2A can be fixed to the body 1A. The same is applied to the second attachment portion 3A, and a set screw N2 with a knob serving as a second fixture is used.

Stated another way, in the moving body mounted device 91A according to the first variation, the body 1, the first attachment portion 2, and the second attachment portion 3 are fixed by performing fastening and fixing in the radial direction by using the first fixture and the second fixture, in contrast to pressing in the axial direction. In this structure, the set screws N1 and N2 respectively serving as the first and second fixtures are rotated about axes orthogonal to the axis CL1 such that fastening and loosening are performed. Therefore, the structure is effective, for example, for attachment to a portion where there is no space for fingers to enter in the crosswise direction.

### (Second Variation)

As illustrated in FIG. 8, a moving body mounted device 91B according to the second variation of the embodiment includes a body 1B, a first attachment portion 2B, a second attachment portion 3B, and two caps 7B1 and 7B2. The body 1B includes protruding shafts 17B that protrude with the axis CL1 as an axis on the left-hand and right-hand surfaces, respectively. The protruding shaft 17B includes an uneven engagement portion 16B at a proximal end and a distal end shaft 15B at a distal end.

The uneven engagement portion 16B includes a plurality of recesses that extends in the axial direction and is formed at a predetermined circumferential pitch on the entire circumferential surface. The distal end shaft 15B is formed at a distal end of the uneven engagement portion 16B to extend further outward with an outer diameter smaller than that of the uneven engagement portion 16B. The first attachment portion 2B includes a through-hole 27B that penetrates with the axis CL1 as an axis. The through-hole 27B includes, in a portion closer to the body 1B, a plurality of protruding rib groups 26B that engages with the uneven engagement portion 16B of the body 1B, and includes, in a remaining portion far from the body 1B, a loosely fitting hole 25B formed with an inner diameter d1 larger than an outer diameter d2 of the distal end shaft 15B of the body 1B. The second attachment portion 3B has a similar structure.

As illustrated in FIG. 8, in inserting the protruding shaft 17B of the body 1B into the through-hole 27B of the first attachment portion 2B, when the protruding shaft 17B has been inserted by a certain distance, the uneven engagement portion 16B and the protruding rib groups 26B can engage with each other at a predetermined circumferential pitch. After this engagement, the protruding shaft 17B is further inserted, and therefore the distal end shaft 15B sufficiently enters the loosely fitting hole 25B, as illustrated in FIG. 8. In this state, an annular space VB is formed between the loosely fitting hole 25B and the distal end shaft 15B.

The cap 7B1 (a first fixture) and the cap 7B2 (a second fixture) are the same members. As illustrated in FIG. 8, the cap 7B1 includes an annular portion 71 that has an annular shape and includes a through-hole 71b, and a flange 72 that closes one end of the annular portion 71, has a diameter larger than a diameter of the annular portion 71, and protrudes radially outward over the entire circumference, and the cap 7B1 is formed of an elastic member. The elastic member is, for example, rubber. An outer diameter d71 of the annular portion 71 is formed to be slightly larger than an inner diameter d1 of the loosely fitting hole 25B of the first attachment portion 2B, and an inner diameter d72 of the through-hole 71b is formed to be slightly smaller than an outer diameter d2 of the distal end shaft 15B.

In the cap 7B1 serving as the first fixture, the annular portion 71 can be inserted into the space VB in a firmly fitting manner, as illustrated as arrow DR8. As a result, due to the frictional force generated according to the repulsive force of elastic compression in the radial direction of the annular portion 71, it is substantially impossible for the distal end shaft 15B to move along the axis CL1 and rotate about the axis CL1 relative to the through-hole 27B. As a result, the first attachment portion 2B is fixed in a desired rotational position relative to the body 1B by the cap 7B1 serving as the first fixture. The same is applied to the second attachment portion 3B, and the second attachment portion 3B is fixed in a desired rotational position relative to the body 1B by the cap 7B2 serving as the second fixture.

Due to firmly fitting and insertion of the caps 7B1 and 7B2, the body 1B, the first attachment portion 2B, and the second attachment portion 3B are integrally fixed in a desired rotation posture. The moving body mounted device 91B according to the second variation has a simple structure, and can fix members by only pushing the caps 7B1 and 7B2 without fastening and loosening a nut member 5, and therefore a fixing task is easily performed.

Examples of the moving body M on which the moving body mounted device 91, 91A, or 91B described above (hereinafter referred to as the moving body mounted device 91 or the like) is mounted include automobiles, railway vehicles, aircrafts, ships, airships, and drones, and an object that actively and passively moves regardless of whether or not a person can board corresponds to the moving body M. The moving body mounted device 91 or the like mounted on the moving body M as described above is not limited to a camera device. For example, the moving body mounted device 91 or the like may be a sensor device that measures the body temperature or the like of an occupant of the moving body M in a non-contact manner, a music reproducing device that provides music to be listened by the occupant in the room RM, a communication terminal that is used for the occupant to communicate with the outside, or a measurement device that measures temperature, humidity, or the like inside or outside the moving body mounted device 91 or the like. Furthermore, the moving body mounted device 91 or the like may be an image projection device that projects an image onto a projection target inside the room RM or a projection target outside the moving body M, or the like. For example, the image projection device projects a navigation image or the like from the inside of the room RM onto the windshield or the like of the moving body M, or the image projection device is installed in the room RM or on an outer surface of the moving body M, and projects information to be reported to another moving body onto a projection target that is arranged on a moving route or in a moving space outside the moving body M.

In a case where these devices clearly include a surface mainly relating to a function, such as an operation surface or an image display surface, an orientation of the functional surface is defined by a direction of a virtual axis that is orthogonal to the functional surface and serves as a functional axis. In addition, in a case where these devices have directivity for most exerting their functions, for example, a direction of sound emitted from a speaker in the case of the music reproducing device, a direction in which the sensitivity of detecting a detection target of the sensor device is the highest in the case of the sensor device, a direction in which the sensitivity of receiving radio waves is the highest in the case of the communication terminal, and the like are taken as a direction of the functional axis.

The optical axis CLc described in the embodiment as above indicates an imaging direction in a case where the moving body mounted device 91 or the like is a camera device, and therefore the optical axis CLc corresponds to a functional axis of the camera device. As described above, the moving body mounted device 91 can be attached in such a way that the direction of the functional axis in the state of being attached to an attachment target member can be rotatably changed, and the moving body mounted device 91 has satisfactory usability.

What is claimed is:

1. A moving body mounted device, comprising:
a body comprising a first through-hole with an axis extending in a first direction as a center;
a first attachment portion arranged on a first side in the first direction relative to the body, and attachable to a first attachment target member of a moving body;
a second attachment portion arranged on a second side opposite to the first side in the first direction relative to the body, and attachable to a second attachment target member of the moving body;
a shaft insertable into the first through-hole; and
a fixture for fixing the shaft, the first attachment portion, and the second attachment portion to each other, wherein
the first attachment portion and the second attachment portion are independently rotatable about the axis relative to the body, and
the fixture is fixed to the shaft that has been inserted into the first through-hole to enable each of the first attachment portion and the second attachment portion to be fixed in a desired rotational position relative to the body.

2. The moving body mounted device according to claim 1, wherein the fixture presses and fixes the body, the first attachment portion, and the second attachment portion in the first direction.

3. The moving body mounted device according to claim 1, wherein the shaft is integrated with the first attachment portion.

4. The moving body mounted device according to claim 1, wherein
the shaft comprises, at least at one end, a male screw column protruding from the first through-hole in a state of being inserted into the first through-hole,
at least one of the first attachment portion and the second attachment portion comprises a second through-hole into which the male screw column is insertable,
the fixture comprises a female screw that is screwed onto a male screw of the male screw column, and
the fixture is screwed to cause the first attachment portion, the body, and the second attachment portion to be pressed against each other in the first direction and be fixed.

5. The moving body mounted device according to claim 1, wherein the fixture comprises a first fixture for fixing the body to the first attachment portion, and a second fixture for fixing the body to the second attachment portion.

6. The moving body mounted device according to claim 1, wherein
the body is provided with a slit opening in the first through-hole,
the shaft comprises an opening extending in a circumferential direction of an internal space, and a terminal provided at an end, and
a first end of a cable is connected to a substrate provided inside the body, and a second end of the cable is connected to the terminal via the slit, the opening, and the internal space of the shaft.

7. A moving body mounted device, comprising:
a body;
a first attachment portion arranged on a first side in a first direction relative to the body and attachable to a first attachment target member of a moving body;
a second attachment portion arranged on a second side opposite to the first side in the first direction relative to the body, and attachable to a second attachment target member of the moving body; and
a fixture for fixing the body, the first attachment portion, and the second attachment portion to each other, wherein
the first attachment portion and the second attachment portion are independently rotatable about an axis extending in the first direction relative to the body,
a first engagement portion is provided on the first side of the body, and a second engagement portion is provided on the second side of the body,
a third engagement portion is provided on a side closer to the body in the first attachment portion,
a fourth engagement portion is provided on a side closer to the body in the second attachment portion, and
in a state where the first engagement portion and the third engagement portion engage with each other, and the second engagement portion and the fourth engagement portion engage with each other, the fixture enables each of the first attachment portion and the second attachment portion to be fixed in desired rotational positions relative to the body.

8. A moving body mounted device, comprising:
a body;
a first attachment portion arranged on a first side in a first direction relative to the body, and attachable to a first attachment target member of a moving body;
a second attachment portion arranged on a second side opposite to the first side in the first direction relative to the body, and attachable to a second attachment target member of the moving body; and
a fixture for fixing the body, the first attachment portion, and the second attachment portion to each other, wherein
in each of a first attachment surface attachable to the attachment target member in the first attachment portion and a second attachment surface attachable to the attachment target member in the second attachment portion, a length in the first direction is shorter than a length in a direction orthogonal to the first direction,
the first attachment portion and the second attachment portion are independently rotatable about an axis extending in the first direction relative to the body, and
the fixture enables each of the first attachment portion and the second attachment portion to be fixed in a desired rotational position relative to the body.
